(19) United States
(12) Patent Application Publication
(10) Pub. No.: US 2011/0143083 A1
(43) Pub. Date: Jun. 16, 2011

(54) CUSHIONED ABSORBENT MAT

(75) Inventor: Iain D. SCORGIE, New York, NY (US)

(73) Assignee: MindsInSync, Inc., New York City, NY (US)

(21) Appl. No.: 12/961,073

(22) Filed: Dec. 6, 2010

Related U.S. Application Data
(60) Provisional application No. 61/290,398, filed on Dec. 28, 2009.

(30) Foreign Application Priority Data
Dec. 4, 2009 (GB) 0921326.5

(51) Int. Cl. D03D 27/00; A01K 1/015; D03D 25/00; B32B 3/26; B32B 7/08

(52) U.S. Cl. 428/95; 428/221; 442/181; 428/304.4; 156/93

(57) ABSTRACT

A cushioned, absorbent article such as a mat including a layer of absorbent, quick-drying woven textile material, a layer of viscoelastic polyurethane foam material having an open cell structure, the layer of foam material being glued and sewed to the layer of woven textile material to form a textile and foam assembly and typically a rubberized base material, glued to a foam material side of the textile and foam assembly.

### CROSS-REFERENCE TO RELATED APPLICATIONS

This application claims the benefit and priority of U.S. Provisional Application No. 61/290,398, filed Dec. 28, 2009 and United Kingdom Patent Application No.: 0921326.5, filed Dec. 4, 2009. The foregoing applications are incorporated herein by reference in their entireties.

### BACKGROUND OF THE INVENTION

The invention to which this application relates is to a fabric or textile article in a form which is typically referred to as a mat and which article is hereinafter referred to as such. However it should be appreciated that any article which can be used as a surface covering and/or can be used to provide comfort to a person sitting, standing or kneeling on the same is incorporated within this application.

### DESCRIPTION OF THE RELATED ART

Conventionally, mats can be used for a number of different purposes such as, for example, the mat can be provided as a floor covering, for a portion of a floor surface or can be put to further use such as, for example, to allow more comfortable seating or kneeling to be achieved by a user who sits or kneels on the mat rather than directly on the floor surface. Mats can also be used in areas which may get wet from time to time such as, for example, on the floor surface adjacent a bath or sink. Furthermore in a tiled bathroom, it is common to provide a bath mat that can both offer a slip-resistant, non-tiled surface on which to stand and some absorbent properties to handle inevitable water from sinks, baths or showers.

However, conventionally, mats tend to be relatively thin and therefore provide little comfort to a person sitting or kneeling on the same on a hard floor surface. Furthermore, if the same become wet the shape and/or appearance of the same can be adversely effected. Furthermore, if the same become wet repeatedly then they can quite often absorb and retain moisture therein and never properly dry out such that the same can start to smell, and/or degrade and/or become generally unattractive for use. This tends to mean that, for example, if a mat is provided for use in a bathroom, the mat can quickly become unhygienic and generally unattractive so that the same may need to be discarded relatively quickly after first being used. As a result, the inventor has determined that there is a need to provide a comfortable, slip-resistant, and absorbent bath mat that is also quick drying.

### SUMMARY OF THE INVENTION

The aim of the present invention is to provide an improvement in the terms of an article such as a mat and an improvement to the structure of the same so as to allow the same to be more comfortable in use, to have more potential uses and/or to have a longer life span.

In a first aspect of the invention, there is provided an article for use as a mat and/or cushion, said article including a layer of compressible material and wherein on at least one surface of the layer of the compressible material there is provided a layer of fabric or textile material.

There is therefore provided an article for use to provide a cushioning and/or moisture absorbency effect.

Typically the layer of fabric or textile material forms the external face of the mat, inasmuch that it is this surface which a person contacts when sitting, kneeling or standing on the mat.

In one embodiment the textile or fabric material layer, can be of uniform colour or may carry a decorative pattern thereon.

In one embodiment, the compressible material layer is formed of a foam. In one embodiment the compressible material used has a memory in as much that if the state of the layer is changed, such as by weight or pressure being applied to the same then, when the means which causes the change is removed, the material at least partially returns to its original state.

Typically, the change in condition of the compressible material is caused by a person applying pressure to the same such as for example, when the person is sitting, kneeling or sitting on the same and, when the person gets up from the mat, the material returns at least partially, to its original state.

In one embodiment the thickness of the compressible material layer is selected with respect to the particular use to which the mat is to be used. For example, a mat which is provided most typically to be stood on may not have as thick a layer of foam as a mat which is provided to be sat or kneeled upon.

In one embodiment, the fabric or textile material layer has good moisture absorbency characteristics. In this embodiment the fabric or textile material layer is formed by a series of loops of fibres which are held mutually together. Typically the ends of each of the fibres are bound onto a backing layer and it is the backing layer which is attached to the layer of compressible material. The loops of fibres are found to provide very good moisture absorbency such that in the majority of cases the moisture which passes onto the mat in use is wholly held within the fabric or textile material layer.

In one embodiment the backing layer of the textile or fabric material layer and/or a further barrier layer provided intermediate the fabric or textile layer and the compressible material layer, act to restrict or prevent the moisture passing into the compressible material layer.

In one embodiment, the fabric or textile material layer comprises polyester and polyamide.

In one embodiment the compressible material which is used is viscoelastic polyurethane foam.

In one embodiment, the mat also includes a base onto which the compressible material layer is located. In one embodiment, the base is formed of a spandex material (SBR).

In one embodiment a series of linear ribs or indents are provided at spaced intervals at least in the fabric or textile layer. The said ribs or indents can be used to improve absorbency of moisture and/or control the passage of moisture through said layer.

Typically, the fabric or textile material layer, compressible material layer and base are laminated together to form a unitary mat.

In another aspect of the invention relates to a method of manufacturing a cushioned, absorbent mat comprising, in the following order, providing an absorbent, quick-drying woven material in a sheet sized for use as a mat, gluing the absorbent, quick-drying woven textile material to a sheet of viscoelastic polyurethane foam material having an open cell structure, sewing the textile material to the foam material to obtain a sewed textile and foam assembly, and gluing a foam material side of the sewed textile and foam assembly to a sheet of non-slip rubberized base material.

Another aspect of the invention relates to a cushioned mat including a layer of absorbent, quick-drying woven textile material, a layer of viscoelastic polyurethane foam material having an open cell structure, the layer of foam material being glued and sewed to the layer of woven textile material to form a textile and foam assembly, and a layer of rubberized base material, glued to a foam material side of the textile and foam assembly.

In accordance with the invention, because the external layer is formed of moisture absorbent material and preferably in the loop structure provided then the moisture is typically wholly or mostly absorbed by the fabric and therefore does not reach the foam. Furthermore because the moisture is held within this layer, it is found that the mat as a whole dries out more quickly, hence reducing the risk of smells and deterioration of the mat occurring.

The provision of the foam provides a comfortable feel to a person when standing, kneeling or sitting on the same.

The provision of the base provides increased slip resistance for the mat on the base.

The mat can be used for any or any combination of uses, such as, changing mat, play mat, pet mat, seat cushion mat, stadium seat cushion mat, picnic seat cushion mat, yoga mat, sports mat, bedroom mat, kitchen mat, kitchen slice mats, computer arm rest mat, tug mat, shoe insoles, crib mat, mattress topper, garden mat, car mat, car seat mat.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designated corresponding parts in the various figures. It is to be expressly understood, however that the drawings are for the purpose of illustration and description only and are not intended as a definition of the limits of the invention. As used in the specification and in the claims, the singular form of “a”, “an” and “the” include plural referents unless the context clearly dictates otherwise.

### BRIEF DESCRIPTION OF THE DRAWINGS

A specific embodiment of the invention is now described with reference to the accompanying drawings wherein;

FIG. 1 illustrates an article in accordance with one embodiment of the invention;

FIG. 2 illustrates a cross section along the line AA of FIG. 1;

FIG. 3 schematically illustrates a cross-sectional view of a strand used in the manufacture of an absorbent fabric or textile layer of an embodiment of a bath mat in accordance with the current invention;

FIG. 4 schematically illustrates a cross-sectional view of a plurality of the stands of FIG. 3 used to form the material of an absorbent fabric or textile layer of an embodiment of a bath mat in accordance with the current invention; and

### DETAILED DESCRIPTION OF THE PREFERRED EMBODIMENTS

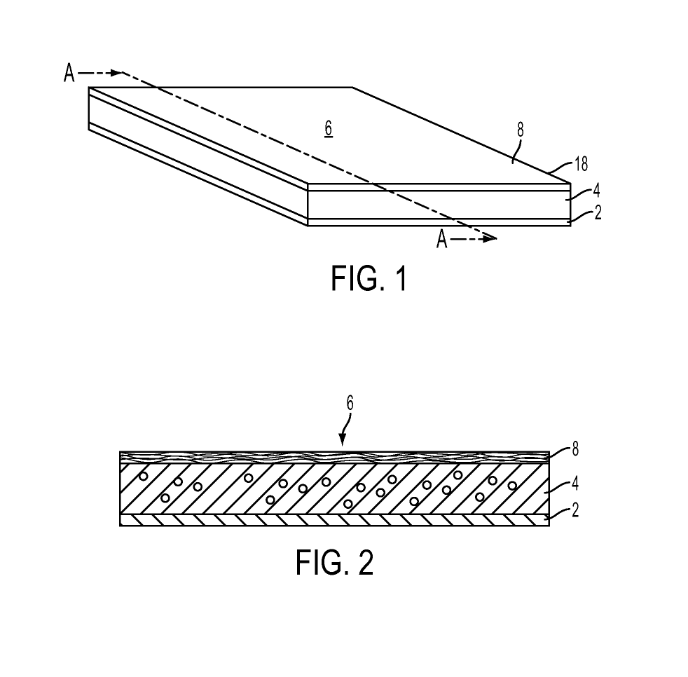

Referring firstly to FIG. 1, there is illustrated an article in the form of a mat in accordance with one embodiment of the invention in which the mat includes a base 2 which is formed of a slip resistant material such as, in this embodiment, that known by the Trade Name spandex. This base material is in turn attached to a compressible material layer or core 4 formed preferably of a memory foam such as viscoelastic polyurethane. The external face 6 of the mat, which is the surface on which a person is most likely to step, kneel or sit, is provided as a fabric or textile material layer 8 which is formed of polyester and polyamide, typically in the range of 75%-85% polyester and 15 to 25% polyamide, more preferably 80% polyester and 20% polyamide.

The arrangements between the different layers of the mat are shown in more detail in FIG. 2. In one embodiment a barrier layer may also be provided between the layer 8 and compressible material layer 4 to prevent moisture from reaching the layer 4 from layer 8.

Typically the mat comprises a 80% Polyester, 20% Polyamide layer 8, Memory foam (Polyurethane foam) layer 4 and a spandex base (SBR) 2.

The provision of the layer 8 on the external face means that, for example, when used adjacent a bath, when a user steps out of the bath and onto the mat, the mat absorbs moisture from the user immediately, drying the feet instantly as the textile material layer 8 is a fast absorbing structure. Normally, with regular mats, once the user steps onto it and then walks off there is a trail of water droplets left, which can be uncomfortable, and even hazardous, and this is avoided in accordance with the present invention.

The provision of the compressible memory foam layer 4 with the combination of the textile layer 8 and non-slip base 2 combine to provide a luxurious cushioned and absorbent feel to the mat when stood, kneeled or sat on, which sensation is not achieved by conventional mats which are formed of only a textile or fabric layer. Conventional mats typically either do not have an anti slip base, or have a sprayed on anti slip effect material which if provided does not provide any cushioning effect.

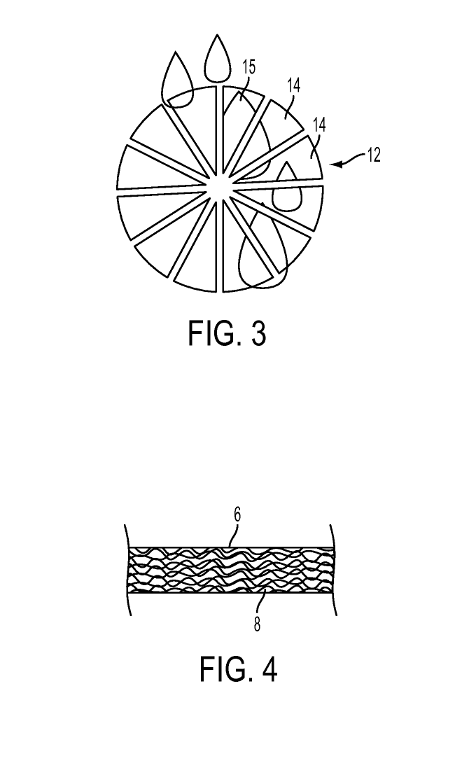

FIG. 3 illustrates in schematic cross-section, a yarn 12 of the type used in the invention to form a woven textile material that forms the absorbent layer 8 of the bath mat. The yarn includes a number of strands of fibers 14, which are divided out from a source fiber and then woven together with a plurality of additional fibers, to form the yarn 12. The provision of the yarn allows the strands and hence the material to be absorbent to water 15 and thereby, rather than deflect liquid from the same, liquid is absorbed quickly and hence removes liquid from the other surface such as the user onto which the material has been applied and provides a drying effect on the other surface. In an embodiment, each fiber 14 has a diameter of the order of a few microns.

For example, an appropriate range may be 1-20 um and a more particular useful range may be 5-10 um. By way of comparison, this range may be thought of as being approximately 100 times finer than human hair and typically 100's of fibers will be used to form each piece of yarn. It will therefore be appreciated that each strand is particularly small in cross-sectional area and, each strand is then used, in combination with other strands, to form a woven material as illustrated in FIG. 4. In an embodiment, the fibers are microfibers having a linear density of less than about 1 denier/filament.

The weaving process to form the material from the yarn includes weaving the yarn together with other stands of yarn to form a woven textile material 8 of the type shown in FIG. 4.

In an embodiment, the woven material comprises a combination of strands of polyester and polyamide, for example, nylon. In particular, an embodiment includes from 60-90% polyester by weight with the remaining polyamide. In order to form a bath mat 18 as illustrated in FIG. 1, a plurality of yarns 2 are woven together to form a woven textile material 8 that has very good absorbency and drying properties. In an embodiment, the fabric is woven into a material having weight between 200 and 300 g/m², and in a particular embodiment, a material having a weight between about 250 and 275 g/m².

In practice, such a material may have an absorbency greatly in excess of conventional cotton terry or polyester woven material. Furthermore, it may have drying speeds faster than conventional cotton terry or even 100% polyester materials. In an embodiment, the woven textile material 6 has a pile height of approximately 0.1-0.175 in particular approximately 0.157 in.

The woven textile material 8 is glued to a cushioning layer 4 using a glue that is, in an embodiment, selected to both provide a strong bond between the polyurethane and the woven material and be sufficiently flexible to allow for bending of the mat without significant cracking of the glue layer. In a particular embodiment, the glue should allow for moisture to pass from the urethane foam to the woven material without blocking the wicking/drying function of the woven material. In a particular embodiment, the glue may be a sprayable upholstery glue suited for use with foam such as 680S, available from Tai Jia of Guangdong, China.

The cushioning layer 4 may be made from a memory foam material, for example a viscoelastic polyurethane foam having an open cell structure. Such material is, in general, absorbent but slow drying particularly as compared to the micro woven material described above.

As an example, the cushioning layer may be about 2.5 cm in thickness, and may generally be within range of 1 cm to 5 cm. For thinner cushioning layer, an insufficient cushioning function may result, while for thicker layers, the overall mat thickness becomes too great and the user may feel as though he or she is sinking too deep into the mat. In a typical mat, the foam density may be approximately 2.8 lbs/ft³.

The inventor has determined that in the above described combination the absorbency and drying properties of the woven textile material layer 8 of the same allows for the use of the relatively absorbent and slow-drying polyurethane foam, even in a generally wet/humid environment such as a bathroom. In this combination the absorbent woven textile material 8 wicks moisture away from the polyurethane layer 4.

Once the woven material layer 8 is glued to the cushioning layer 4 the two can be sewn together for additional strength, and optionally to produce a decorative design on the upper surface 6 of the woven textile material layer 8 not shown.

The sewed and glued combination mat is then glued to the non-slip rubberized base material 2. For example, the non-slip layer may be made from a polyurethane material including, for example, polyurethane-polyurea based spandex. The assembly can then attached to a border which may be made, for example, from a woven polyester material.

In an embodiment, the mat may be between about 4 and 8 square feet in area.

Although the invention has been described in detail for the purpose of illustration based on what is currently considered to be the most practical and preferred embodiments, it is to be understood that such detail is solely for that purpose and that the invention in not limited to the disclosed embodiments, but, on the contrary, is intended to cover modifications and equivalent arrangements that are within the spirit and scope of the appended claims. Foe example, it is to be understood that the present invention contemplates that, to the extent possible, one or more features of any embodiment can be combined with one or more features of any other embodiment.

We claim:

1. A cushioned mat, comprising:
a cushioning layer, comprising an open cell, viscoelastic, polyurethane foam material having a thickness between 1 cm and 5 cm;
a surface layer, comprising a woven textile material comprising microfibers having a linear density of less than about 1 denier/filament and a weight between 200 and 300 g/m2 and having a pile height between 0.1 and 0.175 in;
a flexible glue layer, adhering a first side of the cushioning layer to the absorbent surface layer; and constructed and arranged to allow moisture to be wicked from the cushioning layer to the absorbent surface layer by the woven textile material; and
a non-slip rubberized base material, secured to a second side of the cushioning layer and configured and arranged to allow the mat to sit securely on a floor surface.

2. An article for use as a mat and/or cushion said article including a layer of compressible material and wherein on at least one surface of the layer of the compressible material there is provided a layer of fabric or textile material.

3. An article according to claim 2 wherein the layer of fabric or textile material is a woven textile.

4. An article according to claim 2 wherein the layer of fabric or textile material forms the external face of the article with which a person contacts when sitting, kneeling or standing on the article.

5. An article according to claim 2 wherein the layer of compressible material has a memory inasmuch that if the state of at least a portion of the layer is changed by the application of pressure thereon then when the pressure is removed, the said portion of the compressible material layer at least partially returns to its original state.

6. An article according to claim 5 wherein pressure is applied by any or any combination of a person sitting, kneeling or sitting on the article.

7. An article according to claim 2 wherein the layer of fabric or textile material is capable of absorbing moisture from a surrounding environment or object which is placed in contact therewith.

8. An article according to claim 2 wherein the layer of fabric or textile is formed by a series of loops of fibres which are held mutually together.

9. An article according to claim 8 wherein the ends of each of the fibres are bound onto a backing layer and it is the backing layer which is attached to the layer of compressible material.

10. An article according to claim 2 wherein any moisture which passes onto the layer of fabric or textile is substantially wholly held within the said layer of the article.

11. An article according to claim 10 wherein a backing layer of the layer of fabric or textile material and/or a further barrier layer provided intermediate the layer of compressible material and the layer of fabric or textile material restricts the passage of moisture to the compressible material layer.

12. An article according to claim 2 wherein the fabric or textile material layer comprises polyester and polyamide.

13. An article according to claim 2 wherein the compressible material layer is an open celled material.

14. An article according to claim 13 wherein the compressible material is a polyurethane foam.

15. An article according to claim 2 wherein the article includes a base layer located on the face of the layer of compressible material which opposes that on which the layer of fabric or textile material is located.

16. An article according to claim 15 wherein the fabric or textile material layer, compressible material layer and base layer are laminated together to form a unitary mat.

17. A method of manufacturing a cushioned absorbent mat comprising, in the following order;
providing an absorbent, quick drying layer of woven textile material in a sheet sized for use as a mat;
gluing the absorbent, quick-drying woven layer of textile material to a sheet of viscoelastic polyurethane foam material layer having an open cell structure;
sewing the material to the foam material to obtain a sewed textile and foam assembly; and
gluing a foam material side of the sewed textile and foam assembly to a sheet of non-slip rubberized base material.

18. A method as in claim 17, further comprising:
providing an intermediate backing layer between the textile material and the polyurethane foam material layer.

19. A method as in claim 18, wherein the intermediate backing layer restricts the passage of moisture to the compressible material layer.
